(19) United States
(12) Patent Application Publication
(10) Pub. No.: US 2015/0055552 A1
(43) Pub. Date: Feb. 26, 2015

(54) CONFIGURABLE RF CARRIER PHASE NOISE SHAPING

(71) Applicant: BROADCOM CORPORATION, Irvine, CA (US)

(72) Inventors: Alireza Tarighat Mehrabani, Irvine, CA (US); Behzad Nourani, Irvine, CA (US)

(21) Appl. No.: 14/040,814

(22) Filed: Sep. 30, 2013

Related U.S. Application Data
(60) Provisional application No. 61/869,893, filed on Aug. 26, 2013.

(51) Int. Cl. H04W 24/08; H04L 25/03; H04L 7/033

(52) U.S. Cl. CPC H04W 24/08; H04L 7/0331; H04L 25/03828
USPC 370/328; 375/375; 375/374

(57) ABSTRACT

A method and system is includes configurable carrier phase noise shaping. A fractional phase locked loop (PLL) uses a bank of delta-sigma modulators (DSM) to generate fractional ratios of the reference signal frequency. The bank of delta-sigma modulators provides for dynamic adjustments in the fractional PLL based phase noise performance of the communications network. The bank of DSMs is designed such that they have different and conflicting phase noise profiles. The communication network parameters are monitored and utilized for selecting a specific DSM from the bank of DSMs which most closely resembles a desired communications network phase noise profile.

### CROSS REFERENCE TO PRIORITY APPLICATION/INCORPORATION BY REFERENCE

The present U.S. Utility Patent Application claims priority pursuant to 35 U.S.C. §119(e) to the following U.S. Provisional Application Ser. No. 61/869,893, entitled “Configurable RF Carrier Phase Noise Shaping,” filed Aug. 26, 2013, pending, which is hereby incorporated herein by reference in its entirety and made part of the present U.S. Utility Patent Application for all purposes.

### BACKGROUND

1. Technical Field

The present disclosure described herein relates generally to wireless communications and more particularly to phase noise shaping of wireless communication circuits.

2. Description of Related Art

Communication systems are known to support wireless and wire line communications between wireless and/or wire line communication devices. The communication systems range from national and/or international mobile/handheld systems to the point-to-point gaming, in-home wireless networks, audio, and video wireless devices. Communication systems typically operate in accordance with one or more communication standards. Wireless communication systems operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, and other equivalents communicate directly or indirectly with other wireless communication devices. As wireless capacities for these communication systems continue to grow, it is becoming increasingly more challenging to design higher performing networks while managing current consumption. One of the consequences associated with designing efficient higher performing networks (e.g., LTE 2×2 MIMO, LTE 4×4 MIMO, etc.) is achieving effective phase noise performance. Current system designs aim to maximize phase noise performance without sacrificing other important network parameters.

### BRIEF DESCRIPTION OF THE DRAWING(S)

FIG. 1 is a diagram illustrating a simple 2×2 MIMO scheme in accordance with the present disclosure;

FIG. 2 illustrates a general fractional PLL architecture diagram in accordance with the present disclosure;

FIG. 3 illustrates a configurable fractional PPL architecture diagram in accordance with the present disclosure;

FIG. 4 illustrates example phase noise profiles for various delta-sigma modulators in accordance with the present disclosure;

FIG. 5 illustrates a general flow diagram for configuring a fractional PLL in accordance with the present disclosure;

FIG. 6 illustrates an aspect embodiment of a flow diagram for configuring a fractional PLL in accordance with the present disclosure; and

FIG. 7 illustrates another aspect embodiment of a flow diagram for configuring a fractional PLL in accordance with the present disclosure.

### DETAILED DESCRIPTION

A phase-locked loop or phase lock loop (PLL) is a control system that generates an output signal whose phase is related to the phase of an input signal. While there are several differing types, it generally includes an electronic circuit consisting of a variable frequency oscillator and a phase detector. The oscillator generates a periodic signal. The phase detector compares the phase of that signal with the phase of the input periodic signal and adjusts the oscillator to keep the phases matched. A phase-locked loop can track an input frequency, or it can generate a frequency that is a multiple of the input frequency. These properties are used for computer clock synchronization, demodulation, and frequency synthesis, etc.

PLL noise performance and current consumption, for example to generate transmitter/receiver radio frequency (Tx/Rx RF) carrier tones, may be restrictive in high-performance, low-power Third Generation Long-Term Evolution (3G-LTE) RF integrated circuit (RFIC) designs. For example, achieving phase noise requirements for LTE 2×2 multiple-in, multiple-out (MIMO) communications is challenging and may include high power requirements. Additionally, LTE 4×4 MIMO and future communication configurations may impose additional current consumption requirements.

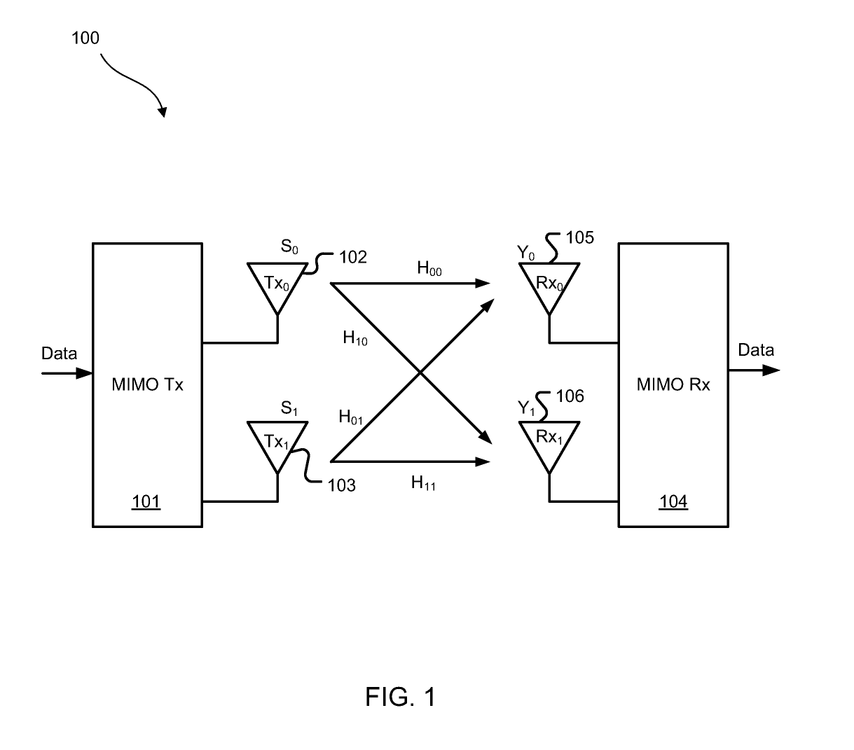

FIG. 1 is a diagram illustrating a simple 2×2 MIMO scheme in accordance with the present disclosure. As shown, MIMO structure 100 includes transmitting (Tx) unit 101 having two antennas 102 and 103, while receiving (Rx) unit 104 is shown having two antennas 105 and 106. It is to be noted that both transmitting unit 101 and receiving unit 104 are generally both transceivers, but are shown as separate Tx and Rx units for exemplary purpose in FIG. 1. That is, Tx unit 101 is transmitting data and Rx unit 104 is receiving the transmitted data. The transmitted data symbols at antennas 102 (Tx₀), 103 (Tx₁) are noted as S₀ and S₁, respectively. The received data symbols at antennas 105 (Rx₀) and 106 (Rx₁) are noted as Y₀ and Y₁ respectively. Since the example illustrates a two transmit antenna/two receive antenna MIMO system, the four resulting RF signal paths are noted as H₀₀, H₀₁, H1₁₀, and H₁₁ (using an H_{Tx-Rx} notation) and the data path is referred to as channel H. While, the example illustrated is a two antenna MIMO structure, the embodiments disclosed herein may operate within other known and future multi-antenna configurations (e.g., 2×4, 2×8, 4×4, 4×8, 4×16, etc.).

Currently, PLL architectures and implementations within the transceivers of MIMO communications systems include fractional PLLs, delivering a “fixed” phase noise shaping profile. Fractional PLLs are based on use of delta-sigma modulators (DSMs) to generate fractional ratios of reference signal frequencies. Due to wireless channeling requirements, modern wireless systems use fractional PLLs (and DSMs) to generate carrier frequencies.

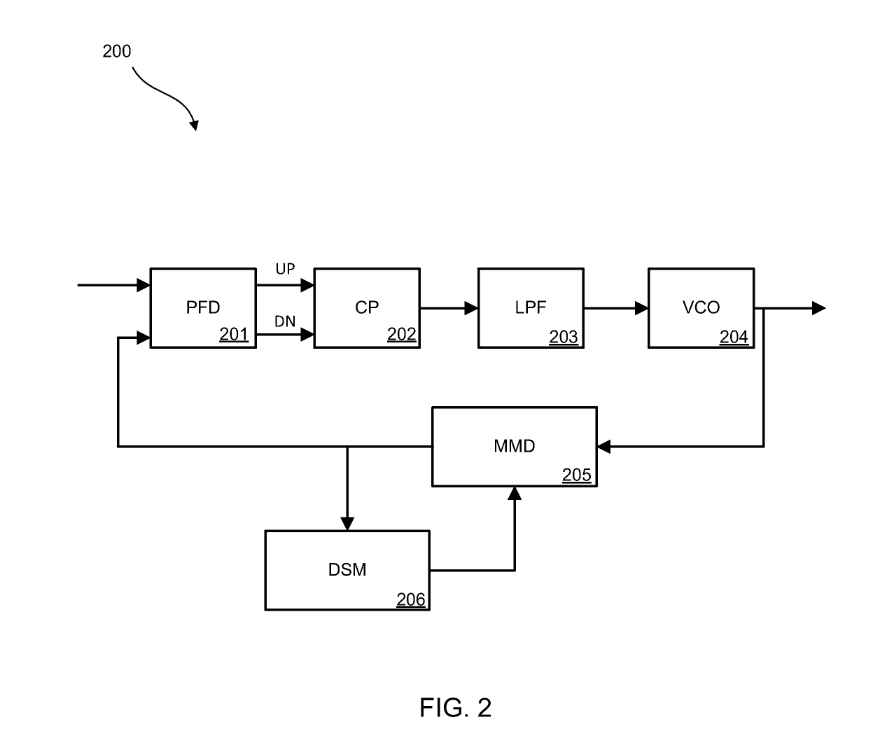

FIG. 2 illustrates a general fractional PLL architecture diagram in accordance with the present disclosure. Fractional PLL 200 includes phase frequency detector (PFD) 201, charge pump (CP) 202, low pass filter (LPF) 203, voltage controlled oscillator (VCO) 204, multiple modulus divider (MMD) 205 and delta-sigma modulator (DSM) 206. The fractional PLL operates by comparing an input signal with a reference signal (feedback signal) to produce an error signal. The phase difference between the reference signal and the input signal is provided by PFD 201 in one of two signals, an up (UP) signal or a down (DN) signal depending on the error signal. The resultant signal controls switches for the current path into and out of PFD 201, causing charge pump 202 to increase or decrease the signal voltage for LPF 203. During each PLL cycle, the phase difference of the error signal is proportional to the time during which the corresponding switch is active making the phase difference directly dependent on the charge delivered. The signal is filtered by LPF 203 and the voltage of the signal tunes VCO 204, generating the desired output signal frequency representative of the oscillation-producing element of the fractional PLL. A feedback loop is provided having MMD 205 for dividing the output signal for feedback into PFD 201. Delta-sigma modulation by DSM 206 of the feedback signal is provided for correcting for variations in the frequency of the feedback signals. Variations may be caused by physical variables such as acoustic pressure, light intensity, etc. and undergo delta-sigma modulation before the feedback signal is feed back into PFD 201.

In signal processing, phase noise profiles represent frequency domains of rapid, short-term, random fluctuations in the phase of a waveform, caused by time domain instabilities. The fixed profile of the fractional PLL needs to meet the specification requirements under multiple usage scenarios and conditions and across a full range of frequencies surrounding the center frequency. Typical fractional PLL designs choose a DSM based on the phase noise profile. The phase noise profile contains two components: close-in noise (frequencies below the carrier frequency) and far-out noise (frequencies above the carrier frequency). Conventional DSMs only affect one component of the phase noise profile. For example, if the DSM reduces close-in noise it would increase far-out noise. Therefore it is difficult to design fractional PLLs that operate effectively on networks with varying conditions or parameters. This existing approach of a “fixed” phase noise profile places unnecessary constraints on the system/circuit designs. It furthermore lacks the flexibility to perform dynamic tradeoffs as the system/chip operating point varies. Overall PLL functions (including local-oscillator generation) in 3G/LTE RFIC, for example, consumes about 30-40% of the overall radio current consumption and is difficult to improve further.

In one or more embodiments of the technology described herein, a fractional PLL architecture is provided having a configurable phase noise profile. The architecture determines the most suitable noise profile based on operating conditions of the wireless communications network and the RFIC.

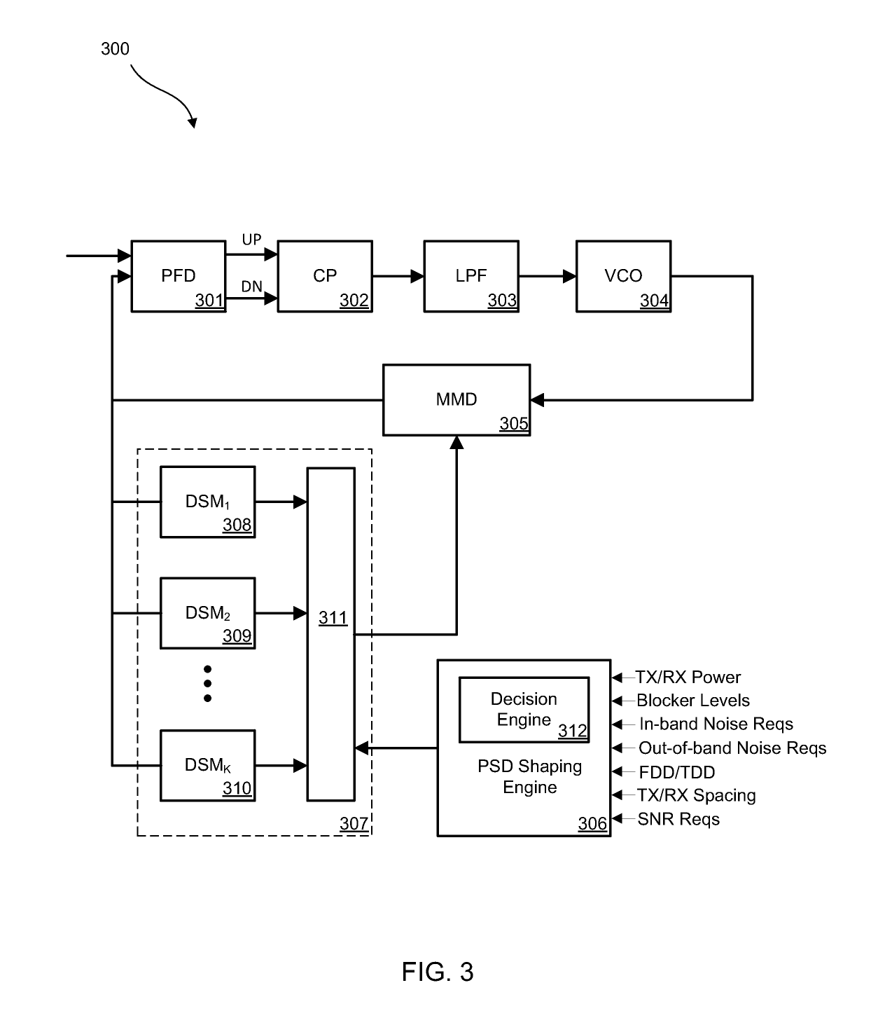

FIG. 3 illustrates a configurable fractional PLL architecture diagram in accordance with the present disclosure. As opposed to a single DSM as presented in FIG. 2, configurable fractional PLL 300 includes a bank of DSMs. The bank of DSMs is designed such that they provide different (and conflicting) phase noise profiles. Some DSMs will have better close-in noise performance (at the expense of higher far-out noise). Some DSMs will have better far-out noise performance (at the expense of higher close-in noise). By monitoring several system/network parameters, the configurable fractional PLL determines which DSM to enable and engage as will be described in further detail hereafter.

Configurable fractional PLL 300 includes PFD 301, charge pump (CP) 302, LPF 303, VCO 304, MMD 305, power spectral density (PSD) shaping engine 306, and DSM bank 307 having DSM₁ 308, DSM₂ 309 and DSM_{K} 310 (where K is an integer value representing the number of DSMs in DSM bank 307). Configurable fractional PLL 300 compares an input signal with a reference signal to produce an error signal. The phase difference between the reference signal and the input signal is provided by PFD 301 in one of two signals, an up (UP) signal or a down (DN) signal depending on the error signal. The resultant signal controls switches for the current path into and out of PFD 301, causing charge pump 302 to increase or decrease the signal voltage for LPF 303 based on the UP or DN signal. During each PLL cycle, the phase difference of the error signal is proportional to the time during which the corresponding switch is active making the phase difference directly dependent on the charge delivered. The signal is low pass filtered by LPF 303 and the voltage of the signal is used to tune VCO 304, generating the desired output signal frequency representing the oscillation-producing element of the fractional PLL. A feedback loop is provided having multiple modulus divider (MMD) for dividing the output signal for feedback into PFD 301.

As shown in FIG. 3, a bank of DSMs is provided in the feedback loop having different and conflicting phase noise profiles. DSM bank 307 is coupled to PSD shaping engine 306. PSD shaping engine 306, having decision engine 312, is coupled to the DSMs 308-310 through multiplexer 311 and, depending on system/network parameters, selects a DSM for the feedback signal. In one embodiment, system/network parameters include, but are not limited to, transmitting/receiving power, blocker levels, in-band phase noise requirements, out-of-band phase noise requirements, network mode of operation, spacing between Rx and Tx bands, and SNR requirements.

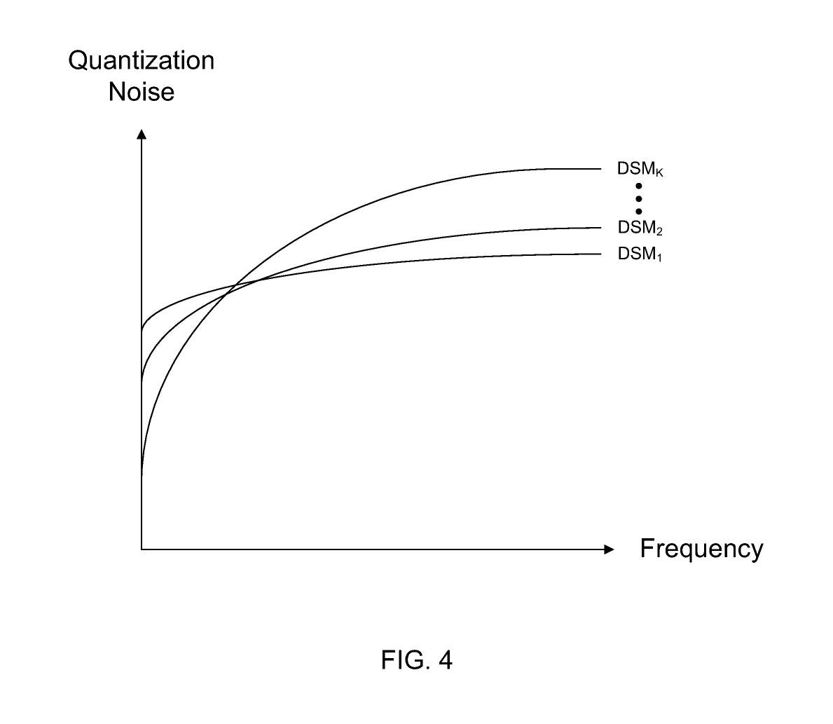

FIG. 4 illustrates example phase noise profiles for various delta-sigma modulators in accordance with the present disclosure. Example noise profiles are provided for DSM₁, DSM₂ and DSM_{K}. DSM₁, for example, shows that the phase noise (quantization noise) is higher relative to DSM₂-DSM_{K} in low frequencies and decreases (relatively) as the frequency increases. Alternatively, DSM_{K} shows low phase noise relative to DSM₁ and DSM₂ at low frequencies and higher relative phase noise at high frequencies (when compared to the phase profiles of the other DSMs within the delta-sigma modulator bank).

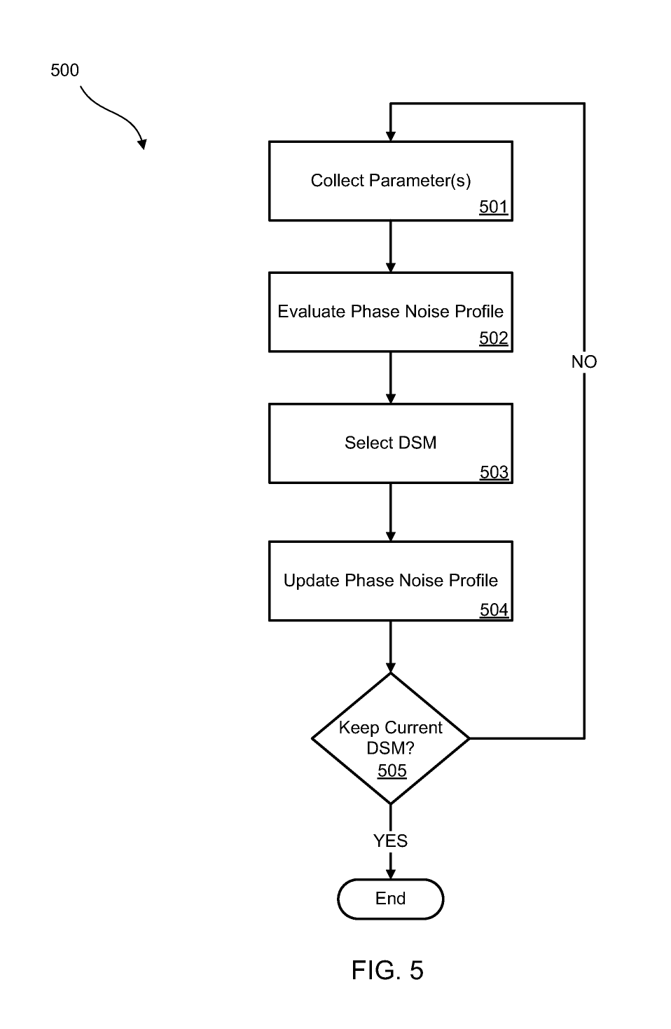

In various embodiments, the communications network parameters are monitored and utilized for dynamic DSM selection. Referring now to FIG. 5, a general flow diagram is provided for configuring the fractional PLL in accordance with the present disclosure. Process 500 begins with the collection of (operational) communication network parameters in step 501. As previously disclosed, network parameters include, but are not limited to, operational parameters such as: transmitting/receiving power, blocker levels, in-band phase noise requirements, out-of-band phase noise requirements, network mode of operation, spacing between Rx and Tx bands, SNR requirements, etc.

In step 502, the phase noise profile for the communications network is evaluated. For example, the level of Tx output power is collected (step 501) and utilized by the decision engine of the PSD shaping engine for driving the selection of a DSM. The phase noise profile for the communications network is evaluated and directs the selection of a specific DSM in step 503. The selection is based on a DSM having a desired phase noise profile which most closely fits (substantially matches) the communications network parameters. For yet another example, in low Tx output powered networks, the Tx PLL degrades far-out noise. In another embodiment, the level of power at the Rx input is used by the PSD shaping engine to determine the DSM selection. For example, for low Rx input power (in FDD mode), the Tx PLL needs to deliver a good far-out noise whereas Rx PLL has relaxed in-band noise.

In step 504, the phase noise profile is updated based on the selected DSM from step 503. The phase noise profile of the selected DSM impacts the overall phase noise performance and stability of the PLL. In one embodiment, phase noise performance thresholds are utilized to determine the effectiveness of a selected DSM in meeting the communication network requirements. In another embodiment, communications network parameters are prioritized where the phase noise performance of one parameter (i.e., Tx power) is prioritized over another parameter (i.e., in-band phase noise requirements).

If the phase noise profile meets the communications network requirements (e.g., phase noise performance thresholds) in step 505, the engaged DSM is maintained and the process is completed. If the engaged DSM phase noise profile does not meet the communications network requirements in step 505, process 500 is iteratively repeated until a DSM is selected and engaged that meets or exceeds the communications network requirements based on overall phase noise performance.

The configurable fractional PLL as described by the technology herein is provided for both frequency division duplex (FDD) and time division duplex (TDD) communication network operating conditions. In a TDD network (e.g. WLAN), only a single configurable fractional PLL is necessary within the transceiver. Alternatively, in a FDD network (e.g., 3G/4G/LTE cellular networks), two configurable fractional PLLs are used for the transceiver. In one embodiment, the network operating conditions (i.e., FDD or TDD) are used as a parameter to determine which DSM to select from the DSM bank. For example, if the network is operating in TDD mode, the Tx PLL and Rx PLL has a degraded far-out noise performance and selects a DSM from the DSM bank accordingly.

In certain embodiments, the spacing between the Tx and Rx carrier frequencies are monitored in a communications network operating in FDD mode. For example, when the spacing between Tx and Rx bands is large, the Tx phase noise present in the Rx band becomes less limited; therefore the selection of DSM for the Tx PLL can have a degraded far-out phase noise performance without having a large impact on the Rx band.

In another embodiment, the signal-to-noise ratio (SNR) is used as a parameter to determining the DSM to select. In one example, the Tx PLL can have a degraded in-band noise performance for a lower side constellation (relaxed Tx error vector magnitude (EVM)/SNR). In another example embodiment, the Rx PLL can have a degraded in-band noise performance for a lower side constellation (relaxed Rx EVM/SNR).

In yet another embodiment, profiles of blockers in the Rx band are used as a parameter to determine which DSM to select. For example, if a large blocker is detected in the Rx band, the Rx PLL phase noise profile at frequencies mapping to those blockers becomes critical.

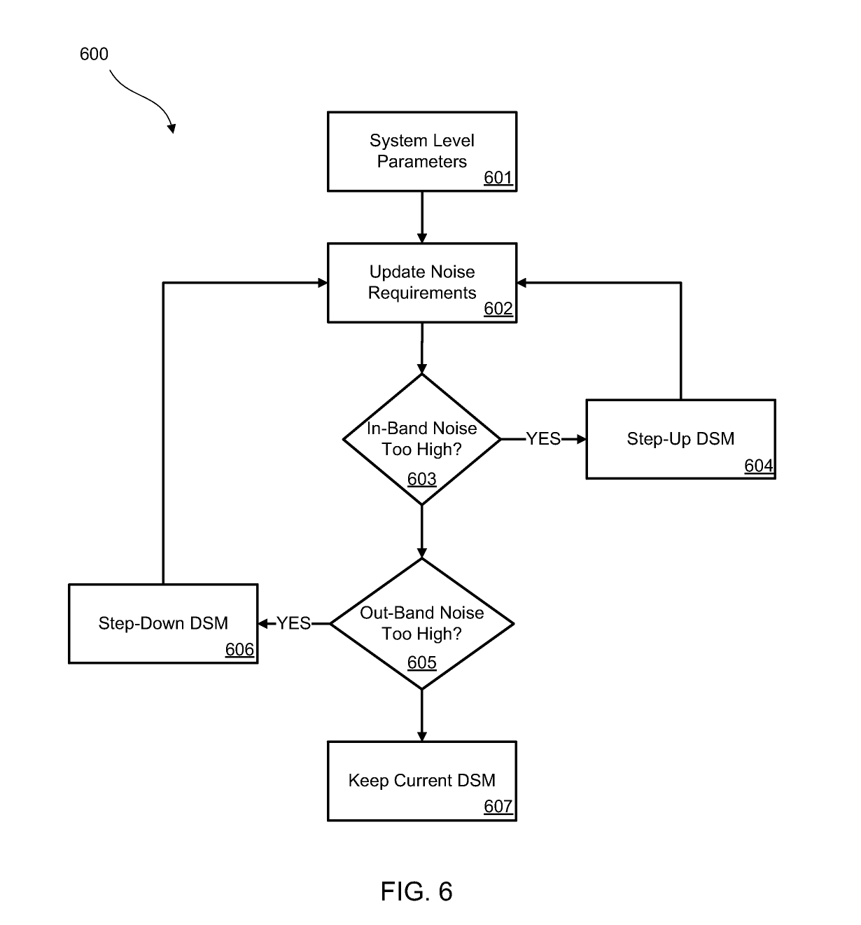

FIG. 6 illustrates an aspect embodiment of a flow diagram for configuring a fractional PLL in accordance with the present disclosure. Process 600 begins with the configurable fractional PLL having an engaged DSM. In one embodiment, the DSM is selected by default settings. In another embodiment, the engaged DSM is selected based on the systems previous operating conditions. The system level parameters are collected by the PSD shaping engine in step 601. In step 602, the in-band and out-of-band phase noise requirements are updated according to the collected system level parameters. In step 603, the in-band phase noise is determined for the engaged DSM. If the in-band phase noise is too high (relative to the communications network requirements), the DSM is stepped-up to increase the order adding more noise-shaping in step 604. If the in-band phase noise is determined not to be too high, step 605 determines if the out-of-band phase noise is too high (relative to the communications network requirements). If the out-of-band phase noise is too high, step 606 steps-down the DSM, decreasing the order and adding less high-band noise. In step 607, where neither the in-band phase noise nor the out-of-band phase noise is too high, the engaged (current) DSM is kept.

DSMs may take a few cycles to be fully operational. As such, in one embodiment of the technology described herein, switching between DSMs (e.g., switching between DSM₁ and DSM₂) is accomplished by creating a steady state (e.g., a few cycles of operation) for DSM₂ before switching over from DSM₁. For example, in order to switch from DSM₁ to DSM₂, both DSM₁ and DSM₂ are engaged. Once the steady state is reached in DSM₂, DSM₁ is disengaged and DSM₂ is fully engaged.

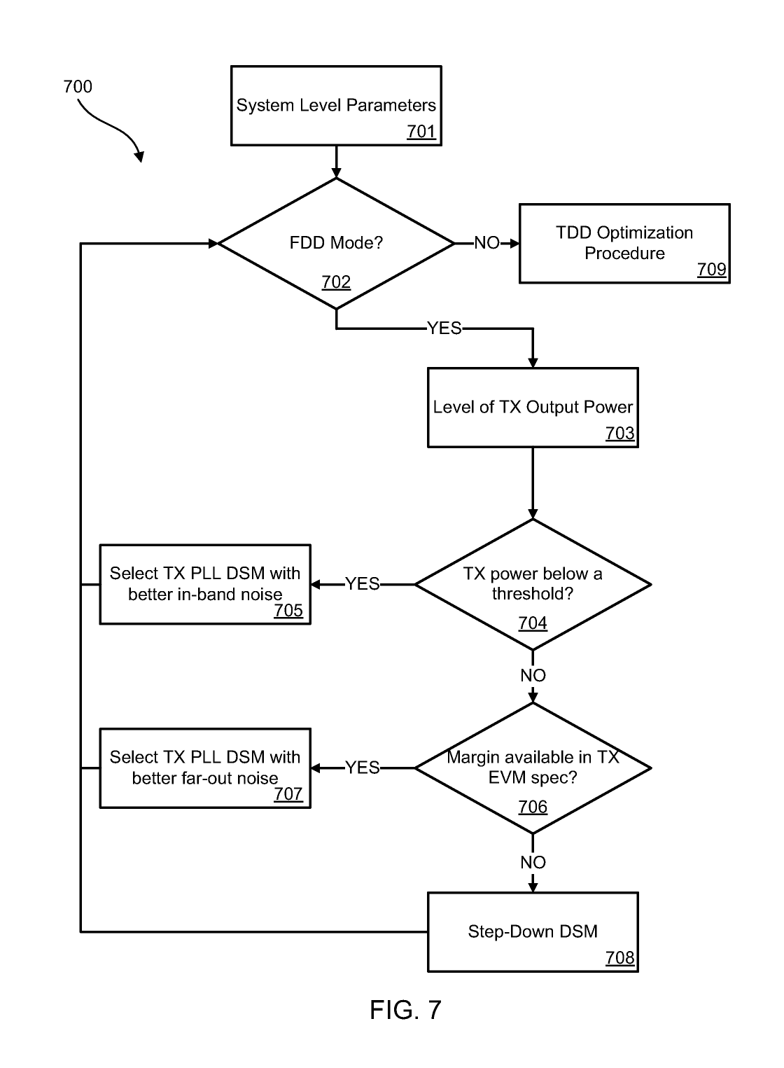

FIG. 7 illustrates another aspect embodiment of a flow diagram for configuring a fractional PLL in accordance with the present disclosure. Process 700 begins with the configurable fractional PLL having an engaged DSM, similar to process 600 of FIG. 6. The system level parameters are collected by the PSD shaping engine in step 701. In step 702, the communications network's mode of operation is determined. For FDD operation, the level of Tx output power is determined in 703. If it is determined in step 702 that the system is not operating in FDD mode, step 709 initiates a TDD optimization procedure to select the most appropriate DSM for that operating environment. In step 704, it is determined if the Tx output power is below a given threshold (e.g., voltage). If the Tx output power is below the threshold, a different DSM is selected having better in-band phase noise. If it is not below the threshold, the EVM specifications are evaluated to determine if a margin is available in step 706. If a margin is available, a different DSM is selected having better in-band phase noise in step 705. If the Tx output power is not below the threshold, a different DSM is selected having better far-out phase noise in step 707. If there is no margin available, the DSM is stepped-down in step 708 and the process is iteratively repeated beginning at step 702 until the DSM is selected that satisfies the system/network parameters.

In alternative embodiments, DSMs in accordance with the present disclosure deploy an internal quantizer to generate the delta-sigma modulated sequence feeding to the fractional PLL MMD. The phase noise profile of the quantizer impacts the overall phase noise performance and stability of the fractional PLL. In another embodiment, a bank of DSMs is implemented with the transceiver with each having a different quantizer profile.

The technology described herein is used for high-performance, low-power communication systems (wireless or wireline). In a wireless domain, it can be highly beneficial for LTE (2×2 MIMO, 4×4 MIMO or higher), 802.11a/n/ac (high constellation) systems, however, it is applicable to any future systems requiring configurable phase noise profiles.

In one or more embodiments the technology described herein the wireless connection can communicate in accordance with a wireless network protocol such as Wi-Fi, WiHD, NGMS, IEEE 802.11a, ac, b, g, n, or other 802.11 standard protocol, Bluetooth, Ultra-Wideband (UWB), WIMAX, or other wireless network protocol, a wireless telephony data/voice protocol such as Global System for Mobile Communications (GSM), General Packet Radio Service (GPRS), Enhanced Data Rates for Global Evolution (EDGE), Personal Communication Services (PCS), or other mobile wireless protocol or other wireless communication protocol, either standard or proprietary. Further, the wireless communication path can include separate transmit and receive paths that use separate carrier frequencies and/or separate frequency channels. Alternatively, a single frequency or frequency channel can be used to bi-directionally communicate data to and from the communication device.

Throughout the specification, drawings and claims various terminology is used to describe the various embodiments. As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship.

In an embodiment of the technology described herein, receiver and transmitter processing modules are implemented via use of a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. In some embodiments, the associated memory is a single memory device or a plurality of memory devices that are either on-chip or off-chip. Such a memory device includes a read-only memory, random access memory, volatile memory, non-volatile memory, static memory, dynamic memory, flash memory, and/or any device that stores digital information. Note that when the processing devices implement one or more of their functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry.

As may also be used herein, the terms “decision engine”, “processing module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The technology as described herein has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed technology described herein. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed technology described herein. One of average skill in the art will also recognize that the functional building blocks, and other illustrative blocks, modules and components herein, can be implemented as illustrated or by discrete components, application specific integrated circuits, processors executing appropriate software and the like or any combination thereof.

The technology as described herein may have also been described, at least in part, in terms of one or more embodiments. An embodiment of the technology as described herein is used herein to illustrate an aspect thereof, a feature thereof, a concept thereof, and/or an example thereof. A physical embodiment of an apparatus, an article of manufacture, a machine, and/or of a process that embodies the technology described herein may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

While particular combinations of various functions and features of the technology as described herein have been expressly described herein, other combinations of these features and functions are likewise possible. The technology as described herein is not limited by the particular examples disclosed herein and expressly incorporates these other combinations.

What is claimed is:

1. A fractional phase-locked loop, comprising:
a phase frequency detector;
a multiple modulus divider;
a delta-sigma modulator bank, including two or more delta-sigma modulators, interconnecting the phase frequency detector and the multiple modulus divider; and
a shaping engine coupled to the delta-sigma modulator bank and configured to select and engage one of the two or more delta-sigma modulators based on a selected noise profile.

2. The fractional phase-locked loop according to claim 1, further comprising:
a charge pump coupled to an output of the phase frequency detector and configured to adjust a voltage of the output from the phase frequency detector;
a low pass filter coupled to an output of the charge pump and configured to pass low-frequency components of the output of the charge pump; and
a voltage controlled oscillator coupled to an output of the low pass filter and configured to adjust a frequency of the output of the low pass filter.

3. The fractional phase-locked loop according to claim 1, wherein the two or more delta-sigma modulators have different noise profiles.

4. The fractional phase-locked loop according to claim 1, wherein the noise profile is selected based on system parameters associated with the fractional phase-locked loop, the system parameters including one or more of: transmitting power, receiving power, blocker levels, in-band phase noise requirements, out-of-band phase noise requirements, mode of operation, transmission spacing, receiving spacing and signal-to-noise requirements.

5. The fractional phase-locked loop according to claim 1, wherein the shaping engine further comprises a decision engine configured to evaluate the system parameters to determine the noise profile closest to a noise profile of the one of the two or more delta-sigma modulators from the delta-sigma modulator bank.

6. The fractional phase-locked loop according to claim 1, wherein the fractional phase-locked loop is integrated into a transceiver.

7. The fractional phase-locked loop according to claim 1, wherein the delta-sigma modulator bank further comprises a multiplexer coupled to the two or more delta-sigma modulators to provide the selection of the one of the two or more delta-sigma modulators.

8. The fractional phase-locked loop according to claim 1, further comprising bringing the delta-sigma modulator selected to a steady state before engaging.

9. The fractional phase-locked loop according to claim 1, wherein the two or more delta-sigma modulators deploy an internal quantizer to generate a delta-sigma modulated sequence feeding to the multiple modulus divider.

10. A method of shaping radio frequency phase noise, comprising:
collecting operational parameters of a communications network;
evaluating one or more phase noise profiles of the communications network based on the collected operational parameters; and
selecting, from a phase-locked loop circuit, a delta-sigma modulator from a bank of two or more delta-sigma modulators, based on a selected one of the evaluated one or more phase noise profiles.

11. The method according to claim 10, wherein the method is repeated until the delta-sigma modulator is selected that substantially matches a desired one of the one or more phase noise profiles of the communications network.

12. The method according to claim 10, wherein the collected operational parameters include one or more of: transmitting power, receiving power, blocker levels, in-band phase noise requirements, out-of-band phase noise requirements, mode of operation, transmission spacing, receiving spacing and signal to noise requirements.

13. A communications network including a phase-locked loop comprising:
a phase frequency detector;
a charge pump coupled to an output of the phase frequency detector and configured to adjust a voltage of a first output signal from the phase frequency detector;
a low pass filter coupled to an output of the charge pump and configured to pass low-frequency components of the first output signal;
a voltage controlled oscillator coupled to an output of the low pass filter and configured to produce a second output signal by adjusting a frequency of the output signal of the low pass filtered first output signal;
a multiple modulus divider coupled to an output of the voltage controlled oscillator and configured to divide the second output signal;
a delta-sigma modulator bank, including at least two delta-sigma modulators, interconnected between the phase frequency detector and the multiple modulus divider; and
a shaping engine coupled to the delta-sigma modulator bank and configured to select and engage one of the at least two delta-sigma modulators based on a noise profile of the communications network.

14. The communications network according to claim 13, wherein the at least two delta-sigma modulators have different noise profiles.

15. The communications network according to claim 13, wherein the noise profile is selected based on operational parameters of the communications network including one or more of: transmitting power, receiving power, blocker levels, in-band phase noise requirements, out-of-band phase noise requirements, mode of operation, transmission spacing, receiving spacing and signal-to-noise requirements.

16. The communications network according to claim 13, wherein the shaping engine further comprises a decision engine configured to evaluate the operational parameters of the communications network to determine selection of the delta-sigma modulator from the delta-sigma modulator bank which has a noise profile which substantially matches the noise profile of the communications network.

17. The communications network according to claim 13, wherein the phase-locked loop comprises a configurable fractional phase-locked loop.

18. The communications network according to claim 17, wherein the configurable fractional phase-locked loop is integrated into one or more transceivers within the communications network.

19. The communications network according to claim 13, further comprising bringing the delta-sigma modulator selected to a steady state before engaging.

20. The communications network according to claim 13, wherein the at least two delta-sigma modulators deploy an internal quantizer to generate a delta-sigma modulated sequence feeding to the multiple modulus divider.
